(19) United States
(12) Patent Application Publication
(10) Pub. No.: US 2026/0044097 A1
(43) Pub. Date: Feb. 12, 2026

(54) SEALING MEMBER, DEVELOPMENT DEVICE, IMAGE FORMING DEVICE, AND SEALING METHOD

(71) Applicant: SHARP KAUSHIKI KAISHA, Sakai city (JP)

(72) Inventor: Tomo HAGINOUCHI, Sakai city (JP)

(21) Appl. No.: 19/281,055

(22) Filed: Jul. 25, 2025

(30) Foreign Application Priority Data
Aug. 6, 2024 (JP) 2024-129835

(51) Int. Cl. G03G 15/08

(52) U.S. Cl. CPC G03G 15/0886; G03G 15/0865; G03G 15/0891

(57) ABSTRACT

A sealing member is a sheet member including a sealing portion that seals a discharge port in a developer discharge unit, a held portion that is connected to an end portion of the sealing portion on a first side in a predetermined connection direction and is detachably held by a holding section provided on the first side of the discharge port in the developer discharge unit in the connection direction, and a fixed portion that is connected to an end portion of the sealing portion on a second side in the connection direction and is detachably fixed to a fixing section provided on the second side of the discharge port in the developer discharge unit in the connection direction.

### TECHNICAL FIELD

The disclosure relates to a sealing member that seals a discharge port of a developer discharge unit in a development device provided in an image forming device such as a copier, a multifunction peripheral, a printer, and a facsimile machine, a development device, an image forming device, and a sealing method.

### BACKGROUND ART

Some image forming devices are shipped and transported, for example, in a state in which developer is stored in a development device including a developer discharge unit provided with a discharge port for discharging the developer. When shipping and transporting such an image forming device, it is necessary to prevent leakage of developer from the development device.

Thus, a sealing member is used in some cases to seal the discharge port of the developer discharge unit in the development device.

As a sealing member in the related art, for example, in order to ensure reliable seal, an adhesive tape that is attached to the discharge port to seal the discharge port, or a molded sealing part that is attached to the discharge port to seal the discharge port has been used.

However, when releasing the discharge port from a sealed state by the sealing member such as the adhesive tape or the molded sealing part, it is necessary to temporarily detach the development device from an image forming device body. When the sealing member is the adhesive tape, there is a problem in that adhesive residue remaining at the sealed area after peeling off the adhesive tape, or damage to the sealed area when peeling off the adhesive tape, are found. Moreover, the adhesive tape once used cannot be reused. When the sealing member is the molded sealing part, the cost is high.

In this regard, it is known that when a shutter (shutter member) moves in a direction to close a toner discharge port, a seal member (sealing member), which is made of a flexible material that can flexibly deform on a surface facing the toner discharge port (discharge port), on a tip side in a moving direction is curled up toward the toner discharge port, thereby coming into close contact with a periphery of the toner discharge port.

### SUMMARY

### Technical Problem

However, in the configuration described in PTL 1, a configuration for sealing the discharge port is complicated and expensive.

Therefore, an object of the disclosure is to provide a sealing member, a development device, an image forming device, and a sealing method that can simplify a configuration for sealing a discharge port and reduce costs.

### Solution to Problem

To solve the problems described above, the disclosure provides a sealing member, a development device, an image forming device, and a sealing method as follows.

### (1) Sealing Member

According to the disclosure, a sealing member is a sheet member that seals a discharge port of a development device including a developer discharge unit provided with the discharge port, through the discharge port, a developer being discharged. The sealing member includes a sealing portion that seals the discharge port in the developer discharge unit, a held portion that is connected to an end portion of the sealing portion on a first side in a predetermined connection direction and is detachably held by a holding section provided on the first side of the discharge port in the developer discharge unit in the connection direction, and a fixed portion that is connected to an end portion of the sealing portion on a second side in the connection direction and is detachably fixed to a fixing section provided on the second side of the discharge port in the developer discharge unit in the connection direction.

### (2) Development Device

According to the disclosure, a development device includes a developer discharge unit provided with a discharge port. The development device includes the sealing member according to the aforementioned disclosure, in which the developer discharge unit includes a holding section provided on the first side of the discharge port in the connection direction, and a fixing section provided on the second side of the discharge port in the connection direction, and in the sealing member, the held portion is detachably held by the holding section in the developer discharge unit, the fixed portion is detachably fixed by the fixing section in the developer discharge unit, and the sealing portion seals the discharge port in the developer discharge unit.

### (3) Image Forming Device

According to the disclosure, an image forming device includes the development device according to the aforementioned disclosure.

### (4) Sealing Method

According to the disclosure, a sealing method using the sealing member according to the aforementioned disclosure includes holding the held portion in the sealing member in the holding section of the developer discharge unit, sealing the discharge port in the developer discharge unit with the sealing portion in the sealing member, and fixing the fixed portion in the sealing member to the fixing section in the developer discharge unit.

### Advantageous Effects of Disclosure

According to the disclosure, it is possible to simplify a configuration for sealing a discharge port and reduce costs.

### BRIEF DESCRIPTION OF THE DRAWINGS

FIG. 1 is a schematic cross-sectional view of an image forming device according to the present embodiment, viewed from the front.

FIG. 2 is an exploded perspective view of the image forming device illustrated in FIG. 1, with an opening/closing door removed and a collection container detached, viewed obliquely from above on a front side.

FIG. 3 is a perspective view of a development device for black color in the image forming device and the collection container, viewed obliquely from above on the front side.

FIG. 4 is a perspective view of the collection container viewed from a rear side.

FIG. 5 is a side view of the development device illustrated in FIG. 3.

FIG. 6 is a perspective view of a shutter member in a closed state and surroundings thereof in the development device illustrated in FIG. 3, viewed obliquely from below.

FIG. 7 is a perspective view of the shutter member in an open state and surroundings thereof in the development device illustrated in FIG. 3, viewed obliquely from below.

FIG. 8 is a perspective view illustrating an example of a sealing member according to the present embodiment.

FIG. 9 is a perspective view viewed obliquely from below illustrating how a discharge port in a developer discharge unit is sealed when the shutter member is in the closed state.

FIG. 10 is a bottom view viewed from the bottom illustrating how the discharge port in the developer discharge unit is sealed when the shutter member is in the closed state.

FIG. 11 is a perspective view viewed from the upper right on the front side illustrating how the discharge port in the developer discharge unit is sealed when the shutter member is in the closed state.

FIG. 12 is a perspective view viewed from the upper left on the front side illustrating how the discharge port in the developer discharge unit is sealed when the shutter member is in the closed state.

FIG. 13 is a perspective view viewed obliquely from below illustrating a state in which the shutter member is in the open state with the discharge port in the developer discharge unit sealed.

FIG. 14 is a bottom view viewed from the bottom illustrating the state in which the shutter member is in the open state with the discharge port in the developer discharge unit sealed.

FIG. 15 is a perspective view viewed from the upper right on the front side illustrating the state in which the shutter member is in the open state with the discharge port in the developer discharge unit sealed.

FIG. 16 is a perspective view viewed from the upper left on the front side illustrating the state in which the shutter member is in the open state with the discharge port in the developer discharge unit sealed.

FIG. 17 is a flow chart depicting steps of a sealing method for sealing the discharge port of the developer discharge unit in the development device with the sealing member.

FIG. 18 is a flow chart depicting steps of an unsealing method for unsealing the discharge port of the developer discharge unit in the development device from a sealed state by the sealing member.

FIG. 19 is a cross-sectional view of another example of a folded portion in the sealing member, viewed from an insertion direction.

FIG. 20 is a front view illustrating an example of a shape of an engagement portion of a fixed portion in the sealing member.

FIG. 21 is a front view illustrating another example of a shape of the engagement portion provided in the fixed portion in the sealing member.

FIG. 22 is a front view illustrating still another example of a shape of the engagement portion provided in the fixed portion in the sealing member.

FIG. 23 is a front view illustrating an example of a state in which the engagement portion illustrated in FIG. 22 is engaged with a fixing section.

FIG. 24 is a bottom view illustrating an aspect in which an elastic member is provided on a peripheral portion in the developer discharge unit with the shutter member removed.

FIG. 25 is a perspective view of an aspect in which an elastic member is provided on the shutter member, viewed obliquely from below.

FIG. 26 is a perspective view illustrating an aspect in which an elastic member is provided on the sealing member illustrated in FIG. 8.

FIG. 27 is a perspective view illustrating a state in which an example of a long member is connected to the sealing member and a detachable part.

### DETAILED DESCRIPTION OF THE INVENTION

Embodiments according to the disclosure will be described below with reference to the drawings. In the following description, the same components are denoted by the same reference signs. The names and functions of the components are also the same. Accordingly, detailed descriptions thereof are not repeated.

### Image Forming Device

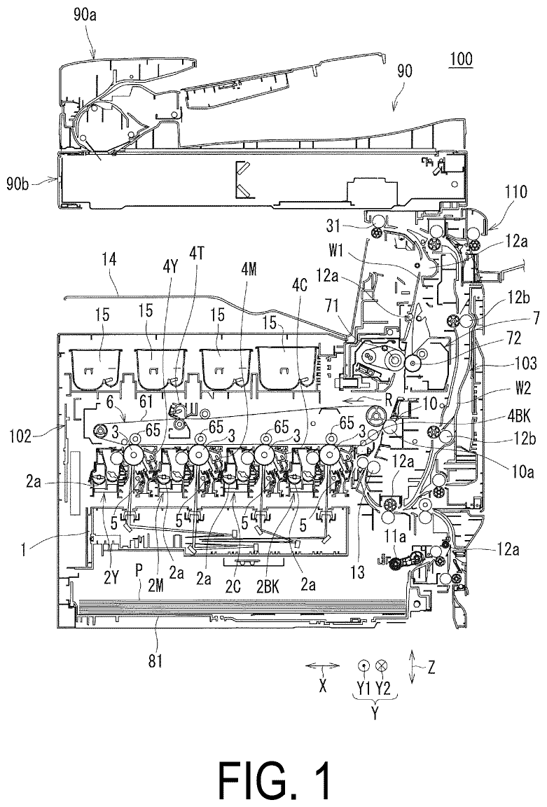

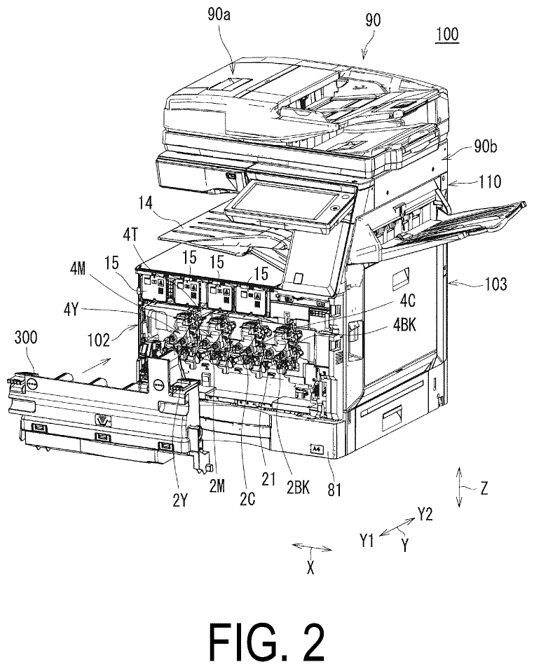

FIG. 1 is a schematic cross-sectional view of an image forming device 100 according to the present embodiment, viewed from the front. FIG. 2 is an exploded perspective view of the image forming device 100 illustrated in FIG. 1, with an opening/closing door removed and a collection container 300 detached, viewed obliquely from above on a front side. In the figures, a letter X represents a left-right direction, a letter Y represents a depth direction, and a letter Z represents an up-down direction (vertical direction).

The image forming device 100 according to the present embodiment is a color image forming device that forms a multicolor or monochrome image on a recording sheet P such as paper. The image forming device 100 performs image forming processing in accordance with image data read by a document reading device 90 or image data transmitted from an external source. Note that the image forming device 100 may be a color image forming device of another configuration. The image forming device 100 may be a monochrome image forming device.

The image forming device 100 includes the document reading device 90 and an image forming device body 110. The image forming device body 110 includes an image forming unit 102 and a sheet feeding system 103.

The image forming unit 102 includes an exposure device 1 (exposure unit), multiple development devices 2BK, 2C, 2M, and 2Y (developing units), multiple photoreceptor drums 3 acting as image carriers, multiple cleaning devices 4BK, 4C, 4M, and 4Y (photoreceptor cleaning units), multiple charging devices 5, an intermediate transfer belt device 6, a cleaning device 4T (belt cleaning unit), multiple toner cartridges 15, and a fixing device 7 (fixing unit). The sheet feeding system 103 includes a feed tray 81, a discharge roller 31, and a discharge tray 14. Here, BK, C, M, and Y stand for black, cyan, magenta, and yellow, respectively. The intermediate transfer belt device 6 includes multiple intermediate transfer rollers 65 and an intermediate transfer belt 61. The intermediate transfer rollers 65 are provided inside the intermediate transfer belt 61. The intermediate transfer belt 61 rotates in a predetermined rotational movement direction R. The intermediate transfer rollers 65 transfer toner images of the respective colors formed on surfaces of the photoreceptor drums 3 onto the intermediate transfer belt 61 in a superimposed manner while rotating in accordance with the rotational movement of the intermediate transfer belt 61.

The document reading device 90 for reading a document (not illustrated) as an image is provided on the top of the image forming device body 110. The document reading device 90 reads a document as an image, and includes a document conveyor 90a and a document reader 90b. The document reading device 90 reads a document as an image using the document reader 90b while conveying the document by the document conveyor 90a, or scans and reads a document placed on a document table of the document reader 90b using the document reader 90b. The image of the document read using the document reading device 90 is sent as image data to the image forming device body 110, and the image is recorded on the recording sheet P.

The image forming device body 110 is provided with a sheet conveyance path W1. A sheet feeder 11a feeds the recording sheet P to the sheet conveyance path W1. The sheet conveyance path W1 guides the recording sheet P to the discharge tray 14 via a transfer roller 10a of a secondary transfer device 10 and the fixing device 7. The fixing device 7 heats and fixes a toner image formed on the recording sheet P to the recording sheet P. Near the sheet conveyance path W1, the sheet feeder 11a, multiple conveying rollers 12a, a registration roller 13, the transfer roller 10a, a fixing roller 71 and a pressure roller 72 in the fixing device 7, and the discharge roller 31 are located.

In the image forming device 100, the recording sheet P fed from the feed tray 81 by the sheet feeder 11a is conveyed to the registration roller 13 via the conveying rollers 12a. Next, the recording sheet P is conveyed to the transfer roller 10a at a timing that allows the recording sheet P to be aligned with the toner image on the intermediate transfer belt 61 by the registration roller 13, and the toner image is transferred onto the recording sheet P by the transfer roller 10a. Thereafter, the recording sheet P passes between the fixing roller 71 and the pressure roller 72 in the fixing device 7, and is discharged onto the discharge tray 14 via the conveying rollers 12a and the discharge roller 31. When an image is to be formed not only on a front side of the recording sheet P but also on a back side, the recording sheet P is conveyed in a reverse direction from the discharge roller 31 to a reverse sheet conveyance path W2. The recording sheet P passes through reverse feeding rollers 12b, and is then turned over and guided again to the registration roller 13. Then, in the same manner as the front side, a toner image is formed and fixed on the back side of the recording sheet P, and the recording sheet P is then discharged toward the discharge tray 14.

The development devices 2BK, 2C, 2M, and 2Y develop electrostatic latent images on the photoreceptor drums 3 using a two-component developer containing toner and carrier as main components. In this example, the development devices 2BK, 2C, 2M, and 2Y are development devices that use a trickle development system. In the toner cartridges 15, carrier is mixed with toner at a fixed ratio. In the development devices 2BK, 2C, 2M, and 2Y, toner is supplied from the toner cartridges 15 to development tanks 2a together with new carrier, while waste developer containing deteriorated carrier is discharged from the development tanks 2a into the collection container 300.

The cleaning devices 4BK, 4C, 4M, and 4Y collect waste toner remaining on the photoreceptor drums 3 without being transferred to the intermediate transfer belt 61 by the intermediate transfer rollers 65, and transport the waste toner to the collection container 300. The cleaning device 4T collects waste toner remaining on the intermediate transfer belt 61 without being transferred to the recording sheet P by the transfer roller 10a of the secondary transfer device 10, and transports the waste toner to the collection container 300.

In the image forming device 100, an image is formed (printed) in the image forming unit 102 using toner supplied from the toner cartridges 15, while powder (waste toner and/or waste developer, in this example, waste toner and waste developer) discharged from the image forming unit 102 is collected in the collection container 300. In this example, the development device 2BK for black color includes a developer discharge unit 21 and discharges the developer for black color (waste developer) into the collection container 300, but the development devices 2C, 2M, and 2Y for cyan, magenta, and yellow do not include the developer discharge unit 21. However, without being limited to this, the development devices 2C, 2M, and 2Y for cyan, magenta, and yellow may each include the developer discharge unit 21 and discharge the developers for cyan, magenta, and yellow into the collection container 300.

The collection container 300 is attached to the image forming device 100 in a direction indicated by an arrow in the figure (Y2 direction). In detail, the collection container 300 is provided on a first side Y1 (in this example, the front side, the operation side) in the depth direction Y to the image forming device body 110, as illustrated in FIG. 2. To be specific, the collection container 300 is detached from the image forming device body 110 to the first side Y1 (in this example, the front side) in the depth direction Y, and is attached from the front side (Y1) toward a second side Y2 (in this example, a rear side) in the depth direction Y, and is then attached to the front of the image forming device body 110.

The collection container 300 stores powder discharged from the image forming device body 110. In detail, the collection container 300 stores toner (waste toner) sent from the cleaning devices 4BK, 4C, 4M, 4Y, and 4T, as well as the developer (waste developer) sent from the development device 2BK.

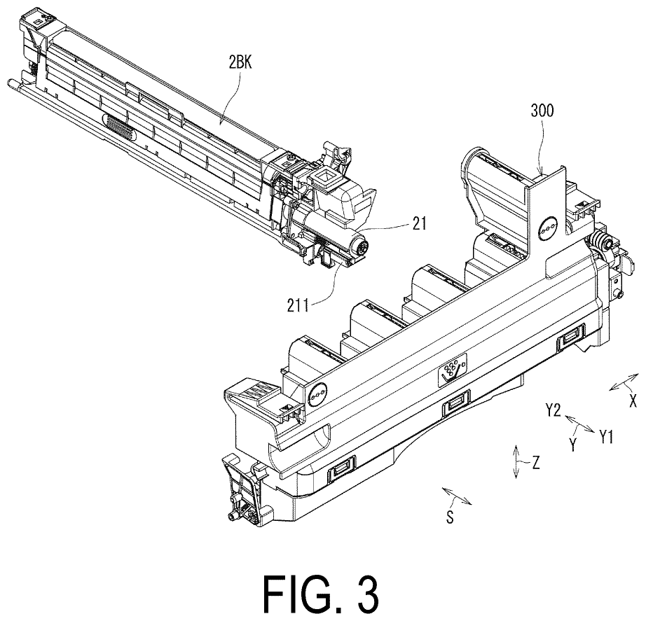

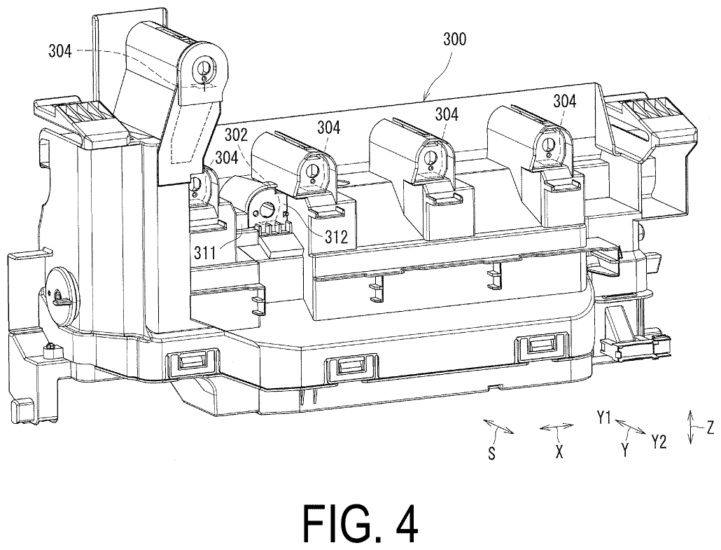

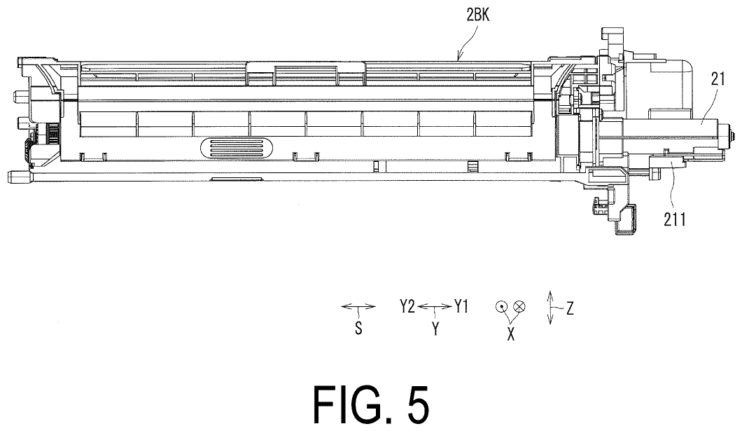

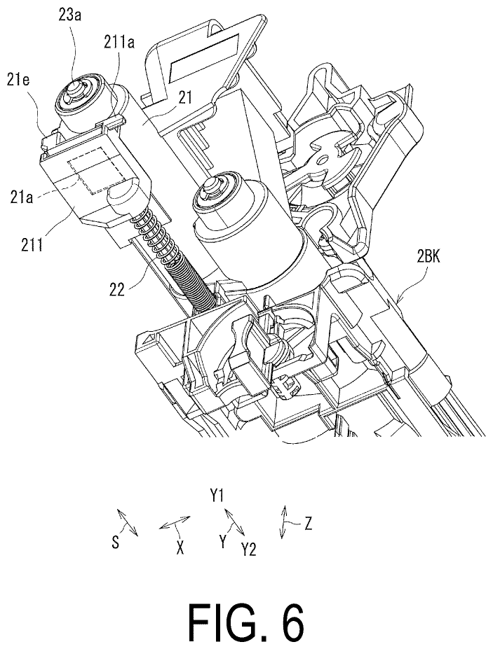

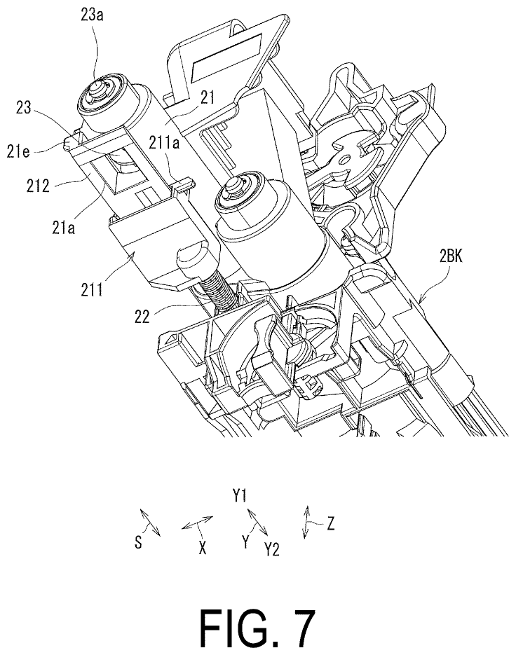

FIG. 3 is a perspective view of the development device 2BK for black color in the image forming device 100 and the collection container 300, viewed obliquely from above on the front side. FIG. 4 is a perspective view of the collection container 300, viewed from the rear side. FIG. 5 is a side view of the development device 2BK illustrated in FIG. 3. FIGS. 6 and 7 are perspective views of a shutter member 211 in the development device 2BK illustrated in FIG. 3 in a closed state and an open state, respectively, as well as surroundings thereof, viewed obliquely from below.

The development device 2BK includes the developer discharge unit 21 from which developer (waste developer) is discharged. As illustrated in FIG. 4, the collection container 300 is provided with a receiving port 302 for developer and receiving ports 304 for toner. The receiving port 302 is an opening for receiving the developer sent from the development device 2BK. The receiving port 302 communicates with the discharge port 21a (see FIGS. 6 and 7) of the development device 2BK with the collection container 300 being attached to the image forming device body 110. The receiving ports 304 are openings for receiving the waste toner sent from the cleaning devices 4BK, 4C, 4M, 4Y, and 4T, respectively. With the collection container 300 being attached to the image forming device body 110, the receiving ports 304 communicate with discharge ports (not illustrated) of the cleaning devices 4BK, 4C, 4M, 4Y, and 4T, respectively.

In the development device 2BK, before the collection container 300 is attached to the image forming device body 110, as illustrated in FIG. 6, the discharge port 21a of the developer discharge unit 21 is closed by the shutter member 211 that is biased to the closing side by biasing force of a biasing member 22 such as a coil spring (see FIGS. 6 and 7) and is restricted by a restricting portion 21e in the developer discharge unit 21. On the other hand, when the collection container 300 is attached to the image forming device body 110, an abutted portion 211a (see FIGS. 6 and 7) provided in the shutter member 211 abuts against an abutment portion 311 (see FIG. 4) provided in the collection container 300, causing the shutter member 211 to move to the opening side against the biasing force of the biasing member 22. At this time, a lid member 312, which is movable in an attachment/detachment direction S of the collection container 300 and is biased toward the second side (Y2) in the attachment/detachment direction S (in this example, the depth direction Y) by a biasing member (not illustrated), abuts against the developer discharge unit 21, thereby retreating to the first side (Y1) in the attachment/detachment direction S. As a result, the developer transported by a transport screw 23 (see FIG. 7), which is rotated, and discharged from the discharge port 21a falls into the collection container 300 through the receiving port 302 of the collection container 300.

In detail, the discharge port 21a is provided at lower part of the developer discharge unit 21. The shutter member 211 is provided to be movable in the attachment/detachment direction S (in this example, the depth direction Y) between an open position and a closed position of the receiving port 302 relative to the lower part of the developer discharge unit 21. The shutter member 211 is provided with the abutted portion 211a on an abutment portion 311 side, the abutted portion 211a being abutted against the abutment portion 311. The biasing member 22 is provided between the shutter member 211 and the developer discharge unit 21 so as to bias the shutter member 211 toward a closed position side (Y1).

In the present embodiment, the development device 2BK includes the developer discharge unit 21. The developer discharge unit 21 includes the discharge port 21a for discharging the developer. The shutter member 211 is provided on the developer discharge unit 21 so as to be capable of opening and closing the discharge port 21a. The collection container 300 stores the developer discharged from the discharge port 21a of the developer discharge unit 21 in the development device 2BK.

### Present Embodiment

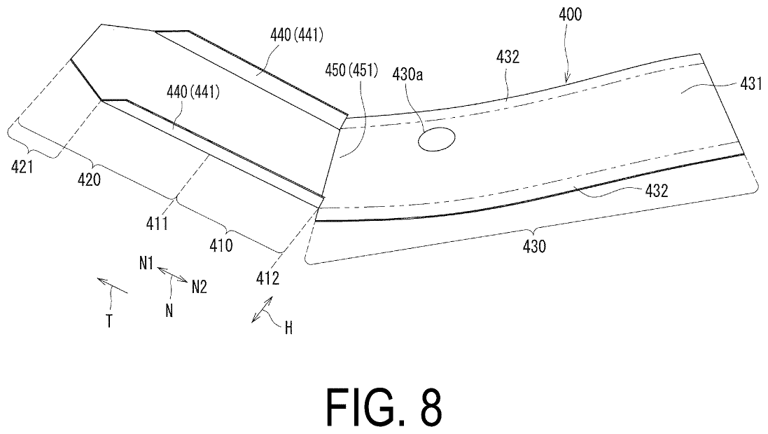

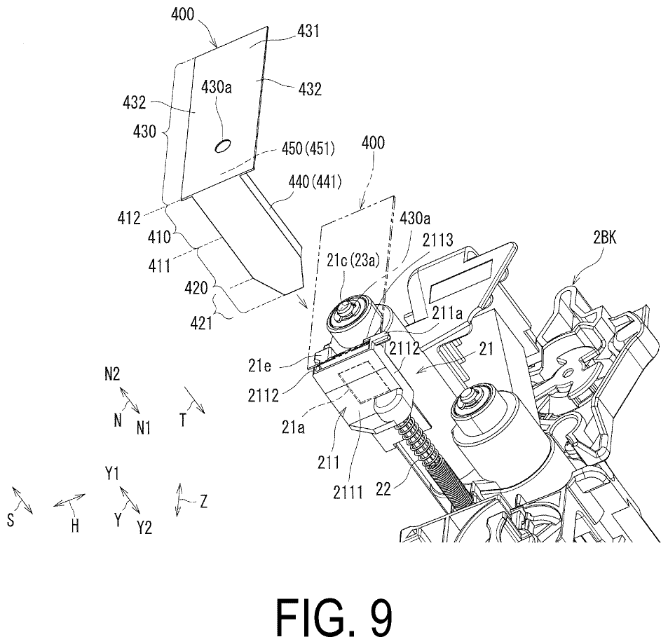

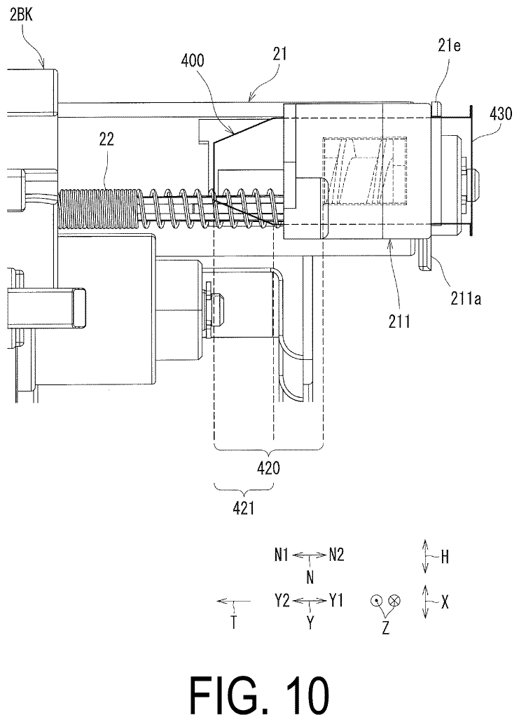

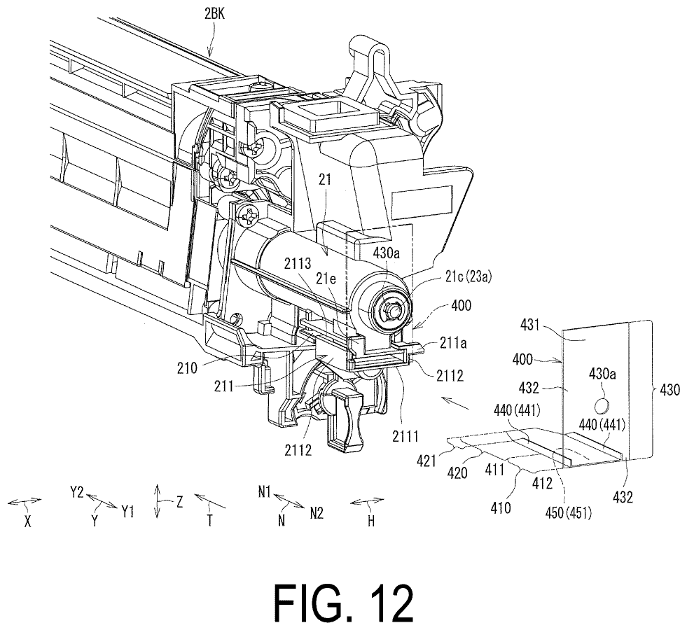

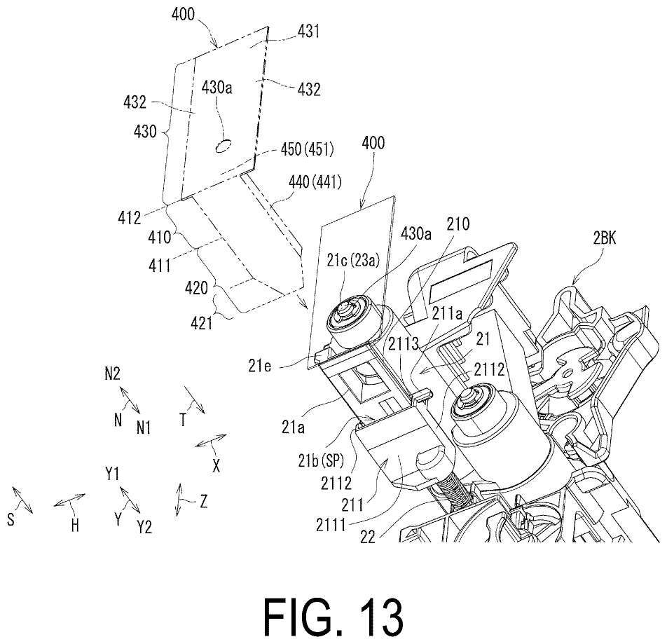

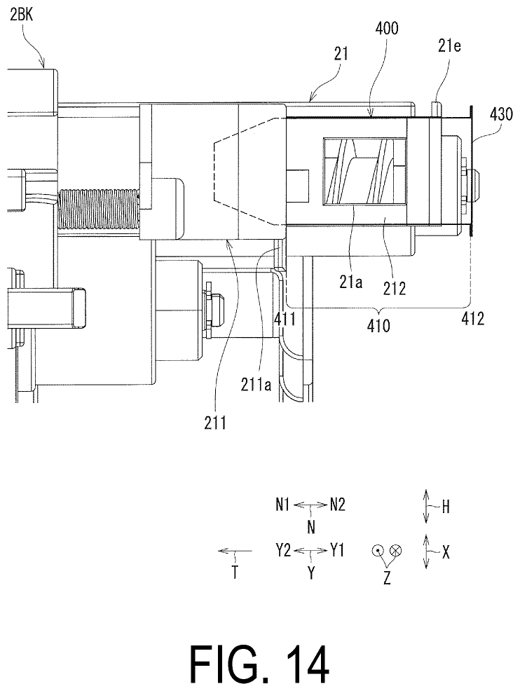

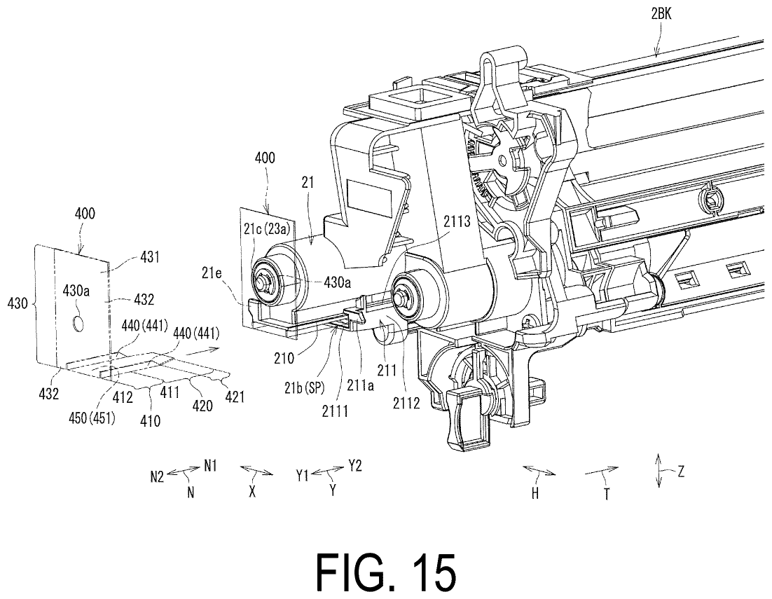

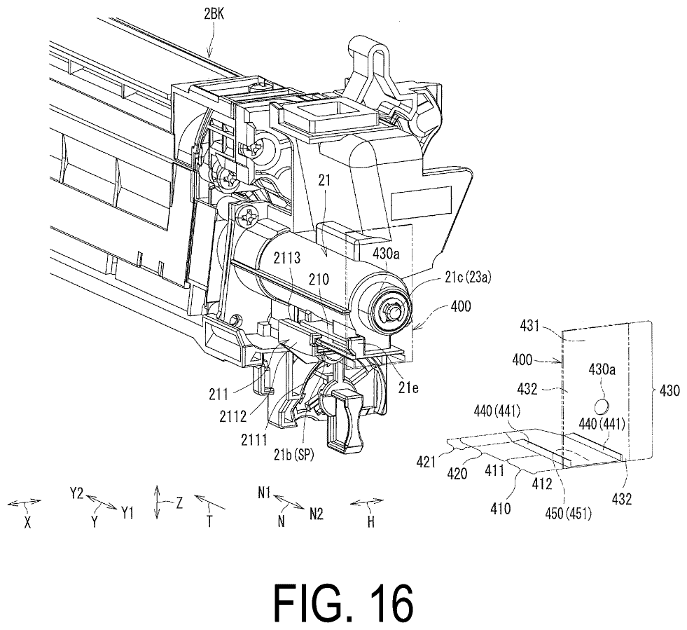

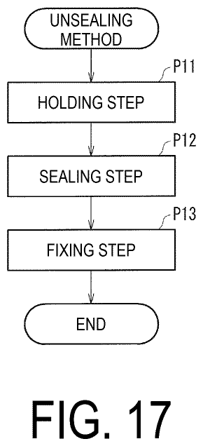

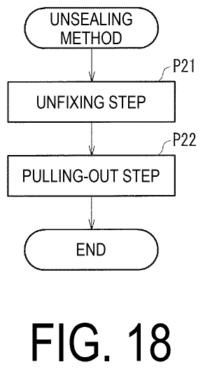

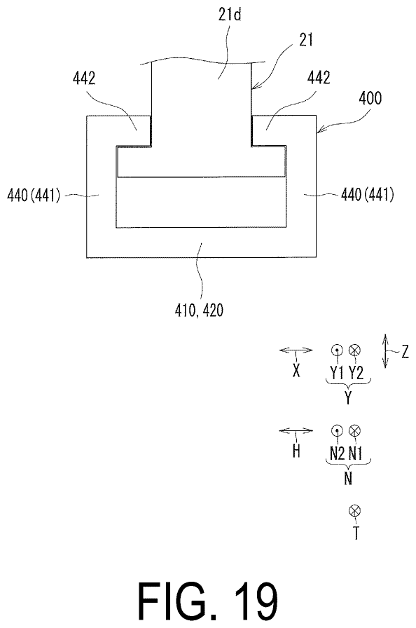

FIG. 8 is a perspective view illustrating an example of a sealing member 400 according to the present embodiment. FIGS. 9 to 12 are a perspective view viewed obliquely from below, a bottom view viewed from the bottom, a perspective view viewed from the upper right on the front side, and a perspective view viewed from the upper left on the front side, respectively, illustrating how the discharge port 21a in the developer discharge unit 21 is sealed when the shutter member 211 is in the closed state. FIGS. 13 to 16 are a perspective view viewed obliquely from below, a bottom view viewed from the bottom, a perspective view viewed from the upper right on the front side, and a perspective view viewed from the upper left on the front side, respectively, illustrating the state in which the shutter member 211 is in the open state with the discharge port 21a in the developer discharge unit 21 sealed. FIG. 17 is a flow chart depicting steps of a sealing method for sealing the discharge port 21a of the developer discharge unit 21 in the development device 2BK with the sealing member 400. FIG. 18 is a flow chart depicting steps of an unsealing method for unsealing the discharge port 21a of the developer discharge unit 21 in the development device 2BK from a sealed state by the sealing member 400. FIG. 19 is a cross-sectional view of another example of a folded portion 440 in the sealing member 400, viewed from an insertion direction T.

In the present embodiment, the development device 2BK includes the developer discharge unit 21 provided with the discharge port 21a, and the sealing member 400 that seals the discharge port 21a. The developer discharge unit 21 includes a holding section 21b and a fixing section 21c. The holding section 21b is provided on a first side N1 of the discharge port 21a in a connection direction N. The fixing section 21c is provided on a second side N2 of the discharge port 21a in the connection direction N.

In the sealing member 400, a held portion 420 is detachably held in the holding section 21b in the developer discharge unit 21, and a fixed portion 430 is detachably fixed to the fixing section 21c in the developer discharge unit 21, so that a sealing portion 410 seals (covers) the discharge port 21a in the developer discharge unit 21.

That is, the sealing member 400 seals the discharge port 21a of the development device 2BK including the developer discharge unit 21 provided with the discharge port 21a for discharging the developer. The sealing member 400 is a single flexible sheet (film) member. Examples of the sealing member 400 include sheet members made of synthetic resins such as polyethylene terephthalate (PET) and polyslider [PA6 (6 nylon)].

The sealing member 400 includes the sealing portion 410, the held portion 420, and the fixed portion 430. The sealing portion 410 seals (covers) the discharge port 21a in the developer discharge unit 21. The held portion 420 is connected to an end portion 411 of the sealing portion 410 on the first side N1 in a predetermined connection direction N. The held portion 420 is detachably held (attached) in the holding section 21b (attachment section) provided on the first side N1 of the discharge port 21a in the developer discharge unit 21 in the connection direction N. The fixed portion 430 is connected to an end portion 412 of the sealing portion 410 on the second side N2 in the connection direction N. Here, the fixed portion 430 may be bent in advance toward the fixing section 21c at the end portion 412 of the sealing portion 410. The fixed portion 430 is detachably fixed (engaged) to the fixing section 21c provided on the second side N2 of the discharge port 21a in the developer discharge unit 21 in the connection direction N.

Note that in the present embodiment, the sealing member 400 seals the discharge port 21a in the development device 2BK, but the development devices 2Y, 2M, and 2C may each include a developer discharge unit 21 provided with a discharge port 21a, and the sealing member 400 may seal the discharge port 21a in each of the development devices 2Y, 2M, and 2C.

In the present embodiment, the sealing method using the sealing member 400 includes a holding step P11, a sealing step P12, and a fixing step P13, as illustrated in FIG. 17.

In the holding step P11, the held portion 420 in the sealing member 400 is held in the holding section 21b in the developer discharge unit 21. For example, the held portion 420 is held in the holding section 21b by an operator or a sealing device (not illustrated).

Examples of the aspect in which the held portion 420 in the sealing member 400 is held detachably in the holding section 21b include an aspect in which the held portion 420 in the sealing member 400 is inserted into a gap SP provided in the developer discharge unit 21 as the holding section 21b, an aspect in which one or more through holes (not illustrated) provided in the sealing member 400 as the held portion 420 engage with one or more protrusions (not illustrated) provided in the developer discharge unit 21 as the holding section 21b. In this example, when the shutter member 211 is in the closed state, a tip portion 421 of the held portion 420 in the sealing member 400 is inserted into the gap SP (holding section 21b).

In the sealing step P12, the discharge port 21a in the developer discharge unit 21 is sealed with the sealing portion 410 in the sealing member 400. For example, the discharge port 21a is sealed with the sealing portion 410 by the operator or the sealing device.

In the fixing step P13, the fixed portion 430 in the sealing member 400 is fixed to the fixing section 21c in the developer discharge unit 21. For example, the fixed portion 430 is fixed to the fixing section 21c by the operator or the sealing device.

This allows the discharge port 21a to be easily sealed with the sealing member 400. In this example, the shutter member 211 is opened when the collection container 300 is attached to the developer discharge unit 21. At this time, with the shutter member 211 open, the discharge port 21a in the developer discharge unit 21 can be sealed with the sealing member 400.

In the present embodiment, the unsealing method for unsealing the sealing by the sealing member 400 includes an unfixing step P21 and a pulling-out step P22, as illustrated in FIG. 18.

In the unfixing step P21, the fixing of the fixed portion 430 in the sealing member 400 to the fixing section 21c in the developer discharge unit 21 is released. In the pulling-out step P22, the fixed portion 430 in the sealing member 400 is pulled out by the operator, so that the sealing member 400 is removed from the developer discharge unit 21.

This ensures that the discharge port 21a can be released from the sealed state by the sealing member 400. Note that when the through hole provided in the held portion 420 in the sealing member 400 is engaged with the protrusion provided in the developer discharge unit 21, the engagement of the through hole with the protrusion is released when the fixing of the fixed portion 430 to the fixing section 21c is released.

According to the present embodiment, the sealing member 400 includes the sealing portion 410 that seals the discharge port 21a, the held portion 420 that is detachably held in the holding section 21b in the developer discharge unit 21, and the fixed portion 430 that is detachably fixed to the fixing section 21c in the developer discharge unit 21. Therefore, when releasing the discharge port 21a from the sealed state by the sealing member 400, it is not necessary to once detach the development device 2BK from the image forming device body 110. Further, since no adhesive is used, no adhesive remains on the sealed area, and the sealed area is not damaged. Furthermore, the sealing member 400 can be reused. In addition, since the sealing member 400 is not a molded sealing part, the configuration for sealing the discharge port 21a is simple, and costs can be kept low, thereby achieving simplification and low costs of the configuration for sealing the discharge port 21a.

When the fixing section 21c is provided below a peripheral portion 212 (flat portion) (see FIGS. 7, 13, and 14) surrounding the discharge port 21a in the developer discharge unit 21, even when the fixed portion 430 in the sealing member 400 is fixed to the fixing section 21c, desired contact between the sealing portion 410 in the sealing member 400 and the discharge port 21a (peripheral portion 212) is not easily obtained.

In this regard, in the present embodiment, the fixing section 21c is provided above the peripheral portion 212 (on the side that enhances the contact with the discharge port 21a). Thus, by fixing the fixed portion 430 in the sealing member 400 to the fixing section 21c, the contact between the sealing portion 410 in the sealing member 400 and the discharge port 21a can be improved.

### First Embodiment

In a state where the held portion 420 in the sealing member 400 is held in the holding section 21b in the developer discharge unit 21 and the fixed portion 430 in the sealing member 400 is fixed to the fixing section 21c in the developer discharge unit 21, when the sealing portion 410 is bent relative to the peripheral portion 212, which surrounds the discharge port 21a, in the developer discharge unit 21 (when a gap between the sealing portion 410 and the peripheral portion 212 is larger), the performance of the sealing portion 410 that seals the discharge port 21a (the peripheral portion 212 surrounding the discharge port 21a) is reduced, thereby making it easier for the developer to leak from the discharge port 21a. Here, the peripheral portion 212 is a predetermined area around the discharge port 21a.

In this regard, in the present embodiment, at least all or part of the sealing portion 410 of the sealing portion 410 and the held portion 420 (in this example, all of the sealing portion 410 and part of the held portion 420) includes the folded portion 440. The folded portion 440 is folded toward both side surface sides of the peripheral portion 212 along both end sides of the peripheral portion 212 in a width direction H orthogonal to the connection direction N. In this example, the folded portion 440 is a pair of folded pieces 441 erected from both end portions of the entire sealing portion 410 and part of the held portion 420 in the width direction H toward both side surface sides of the peripheral portion 212. Note that the peripheral portion 212 may extend toward the side facing the held portion 420.

In this configuration, the folded portion 440 is folded toward both side surface sides along both end sides of the peripheral portion 212 in the width direction H, thereby eliminating the deflection of the sealing portion 410 relative to the peripheral portion 212 (reducing the gap between the sealing portion 410 and the peripheral portion 212). This improves the performance of the sealing portion 410 to seal the discharge port 21a (the peripheral portion 212 surrounding the discharge port 21a), thereby suppressing leakage of the developer from the discharge port 21a. Further, when the held portion 420 includes the folded portion 440, the held portion 420 can be easily held in (attached to) the holding section 21b along the folded portion 440.

As illustrated in FIG. 19, the folded portion 440 may include bent portions 442 further bent inwardly at tips of the pair of folded pieces 441, and the bent portions 442 may be supported by a support portion 21d that is provided in the developer discharge unit 21 and has a T-shape in cross section.

### Second Embodiment

In the present embodiment, the holding section 21b has the gap SP between the peripheral portion 212 and a component of the development device 2BK. The held portion 420 is inserted into the gap SP and is thereby held in the gap SP (holding section 21b). An example of the component of the development device 2BK that forms the gap SP with the peripheral portion 212 is the shutter member 211 that opens and closes the discharge port 21a with the gap SP existing between the shutter member 211 and the peripheral portion 212. In addition to the shutter member 211, the holding section 21b may be provided separately. For example, a bridging portion may be provided across both end portions of the peripheral portion 212 in the width direction H so as to straddle the discharge port 21a with the gap SP existing between the bridging portion and the peripheral portion 212.

In this configuration, the held portion 420 can be held inserted in the gap SP (holding section 21b) between the peripheral portion 212 and the component of the development device 2BK. This allows the held portion 420 to be simply and easily held in the holding section 21b.

### Third Embodiment

In the present embodiment, the tip portion 421 of the held portion 420 is formed in a tapered shape such that the width in the width direction H orthogonal to the insertion direction T of the held portion 420 becomes narrower on a downstream side as a distance from the sealing portion 410 in the insertion direction T increases. The tapered shape may be triangular as in the present embodiment, or both corners of the tip portion 421 of the held portion 420 in the width direction H may be chamfered or rounded. Here, the term “chamfered” refers to an inclined shape inclined relative to each of both sides in the width direction H, and the term “rounded” refers to a convex shape provided between each of both sides in the width direction H and the tip side.

In this configuration, the tip portion 421 of the held portion 420 is formed in the tapered shape, making it easier to insert the tip portion 421 of the held portion 420 into the gap SP (the holding section 21b), thereby improving the operability of holding the held portion 420 in the holding section 21b by an operator.

### Fourth Embodiment

When the operator inserts the held portion 420 into the gap SP, the operator may insert the held portion 420 excessively beyond a reference sealing position for the sealing portion 410 (a position where the sealing portion 410 seals the discharge port 21a).

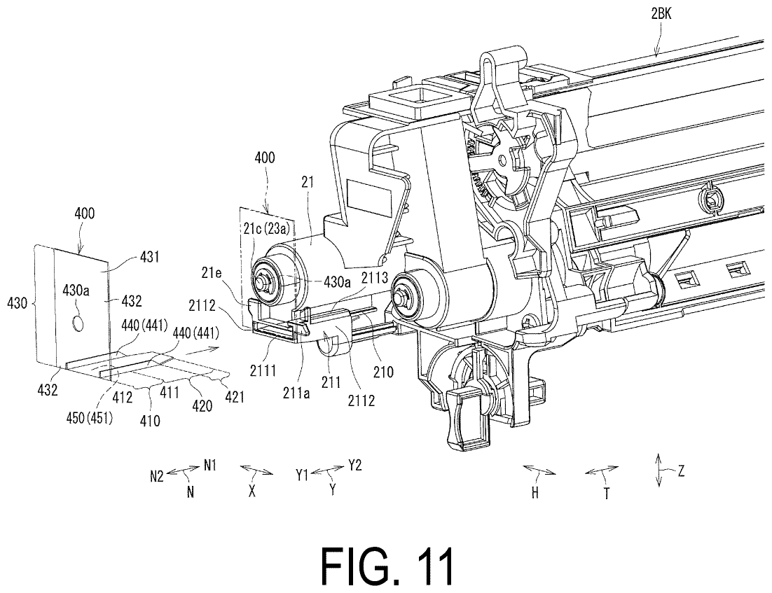

In this regard, in the present embodiment, the sealing member 400 further includes a restricting portion 450. The restricting portion 450 restricts movement of the sealing portion 410 to the downstream side in the insertion direction T of the held portion 420 from the reference sealing position when the held portion 420 is inserted into the gap SP. In this example, as illustrated, for example, in FIG. 11, the restricting portion 450 includes an abutment portion 451 that is bent toward the fixing section 21c at the end portion 412 of the sealing portion 410 in the sealing member 400 and abuts against a tip portion of the developer discharge unit 21.

In this configuration, when the held portion 420 is inserted into the gap SP, the restricting portion 450 can effectively prevent the held portion 420 from being inserted too far to the downstream side in the insertion direction T from a reference insertion position. In this example, the sealing member 400 is bent toward the fixing section 21c at the end portion 412, so that the abutment portion 451 abuts against the tip portion of the developer discharge unit 21, effectively preventing the held portion 420 from being inserted too far to the downstream side in the insertion direction T from the reference insertion position.

### Fifth Embodiment

In the present embodiment, the component of the development device 2BK is the shutter member 211 that opens and closes the discharge port 21a with the gap SP existing between the shutter member 211 and the peripheral portion 212. The held portion 420 is inserted into the gap SP between the peripheral portion 212 and the shutter member 211, and is thereby held in the gap SP (holding section 21b).

In this configuration, the existing shutter member 211 can be used as the component of the development device 2BK that forms the gap SP with the peripheral portion 212 in the developer discharge unit 21. This eliminates the need to provide a separate member for forming the gap SP with the peripheral portion 212 as the component of the development device 2BK, thereby achieving a simpler configuration and lower costs.

In this example, a pair of slide portions 210 extending in the attachment/detachment direction S are provided at both end portions of the lower part of the developer discharge unit 21 in the width direction H. The shutter member 211 includes a flat plate portion 2111, a pair of upright portions 2112, and a pair of sliding portions 2113. The flat plate portion 2111 faces the discharge port 21a. The pair of upright portions 2112 are erected upward from both end portions of the flat plate portion 2111 in the width direction H, respectively. The pair of sliding portions 2113 are each bent from tip portions of the pair of upright portions 2112 toward the pair of slide portions 210, and slide on the pair of slide portions 210. This allows the shutter member 211 to slide in the attachment/detachment direction S relative to the developer discharge unit 21.

### Sixth Embodiment

In the configuration described in PTL 1, when the shutter member is in the open state, the discharge port is open, so in the case where the image forming device is shipped and transferred with the developer stored in the development device, the developer leaks out from the discharge port.

In this regard, in the present embodiment, the held portion 420 is inserted into the gap SP (the holding section 21b) even when the shutter member 211 is in the open state. For example, even when the shutter member 211 is in the open state, the held portion 420 is inserted into the gap SP by about 1 cm or more. That is, the held portion 420 has a length such that a tip side of the held portion 420 reaches the gap SP (e.g., between an elastic member 213 and the peripheral portion 212) when inserted into the gap SP, even when the shutter member 211 is in the open state (e.g., even when the elastic member 213 is provided on the shutter member 211 and the elastic member 213 is at the back side).

In this configuration, regardless of the open/closed state of the shutter member 211 (even when the shutter member 211 is in the open state), a held state in which the tip side of the held portion 420 is inserted into the gap SP (holding section 21b) (e.g., a state in which the held portion 420 is inserted into the gap SP by about 1 cm or more when the shutter member 211 is in the open state) can be kept, thereby keeping the discharge port 21a sealed. As a result, even when the shutter member 211 is in the open state and the discharge port 21a is opened, the sealing portion 410 in the sealing member 400 can suppress leakage of the developer from the discharge port 21a.

When the collection container 300 is attached to the developer discharge unit 21, the shutter member 211 is in the open state. However, there is a known image forming device including a collection container to which a switching member is added for switching the shutter member 211 to a closed state or an open state when the collection container 300 is attached to the developer discharge unit 21. However, in such an image forming device, the switching member is added to the collection container, which leads to an increase in the cost of the collection container.

In this regard, in the present embodiment, there is no need to add a switching member to the collection container 300 to switch the shutter member 211 to the closed state or the open state, thereby effectively preventing an increase in the cost of the collection container 300.

### Seventh Embodiment

In the present embodiment, the fixed portion 430 includes an extension portion 431 that extends beyond the fixing section 21c on an opposite side of the discharge port 21a.

In this configuration, when the operator pulls out the fixed portion 430 to release the discharge port 21a from the sealed state by the sealing member 400, the operator can grasp the extension portion 431 in the fixed portion 430 that extends beyond the fixing section 21c on the opposite side of the discharge port 21a. This improves the operability of the operator in pulling out the fixed portion 430. In this example, the fixed portion 430 includes a pair of protruding pieces 432 protruding outward in the width direction H of the peripheral portion 212.

### Eighth Embodiment

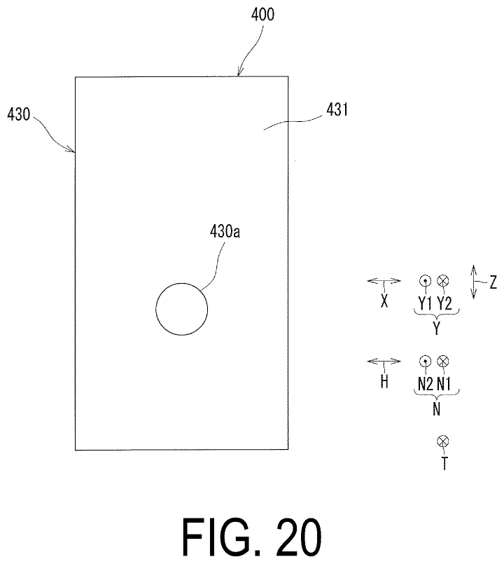

FIG. 20 is a front view illustrating an example of a shape of an engagement portion 430a of the fixed portion 430 in the sealing member 400.

In the present embodiment, the fixed portion 430 includes the engagement portion 430a having the same shape as the shape of the fixing section 21c, and is fixed by engaging the engagement portion 430a with the fixing section 21c.

In this configuration, the fixed portion 430 can be fixed by engaging the engagement portion 430a, which has the same shape as all or part of the fixing section 21c, in the fixed portion 430 with the fixing section 21c. Therefore, the fixed portion 430 can be reliably fixed to the fixing section 21c.

Examples of the shape of the fixing section 21c include a circular shape, an elliptical shape, and a polygonal shape such as a square shape. In this example, the shape of the fixing section 21c is a circular shape (to be specific, a shape of a rotary shaft 23a of the transport screw 23 viewed from the front), and the shape of the engagement portion 430a is a shape of a circular through hole. The fixing section 21c may be the rotary shaft 23a of the transport screw 23 as illustrated, for example, in FIG. 9, or may be a separate protrusion.

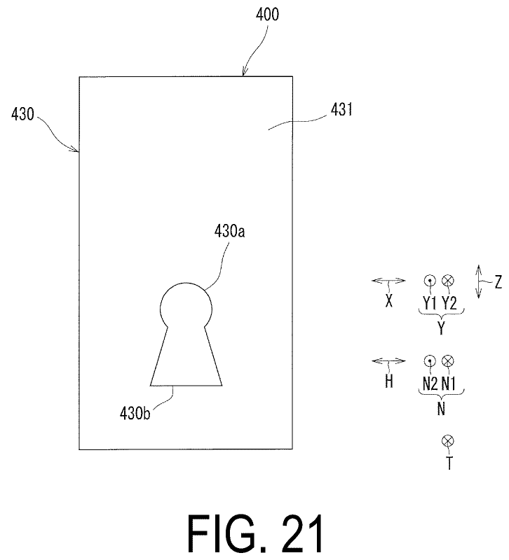

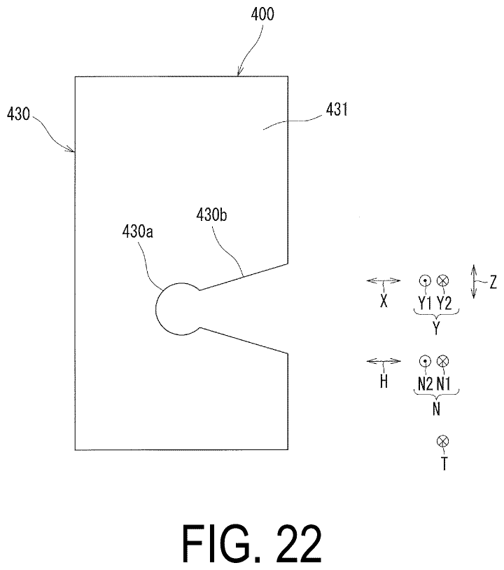

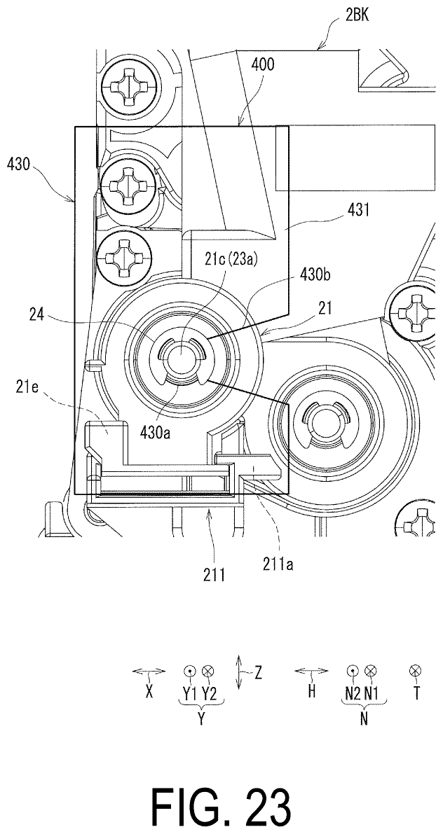

FIGS. 21 and 22 are front views illustrating another example and still another example of the shape of the engagement portion 430a provided in the fixed portion 430 in the sealing member 400, respectively. FIG. 23 is a front view illustrating an example of a state in which the engagement portion 430a illustrated in FIG. 22 is engaged with the fixing section 21c (23a).

As illustrated in FIGS. 21 and 22, the fixed portion 430 may be provided with a communication portion 430b that communicates with the engagement portion 430a. The shapes of the engagement portion 430a and the communication portion 430b are shapes so as to be detachably attached to the inside of a fastener such as a C-ring or an E-ring (in this example, an E-ring 24 [see FIG. 23)] provided on the rotary shaft 23a of the transport screw 23. In this way, by providing the communication portion 430b in the fixed portion 430, the fixing section 21c (23a) can be easily fitted into the fastener (24) due to the communication portion 430b when fixing the fixed portion 430 to the fixing section 21c (23a), and after the fixed portion 430 is fixed to the fixing section 21c (23a), the fastener (24) can make the fixed portion 430 more difficult to be detached from the fixing section 21c (23a). The shape of the engagement portion 430a and the communication portion 430b may be a keyhole shape in which a portion including one apex of a triangular shape communicates with the engagement portion 430a. As illustrated in FIGS. 22 and 23, in the keyhole shape of the engagement portion 430a and the communication portion 430b, the base opposite the engagement portion 430a may be open to the outside (may be cut out).

### Ninth Embodiment

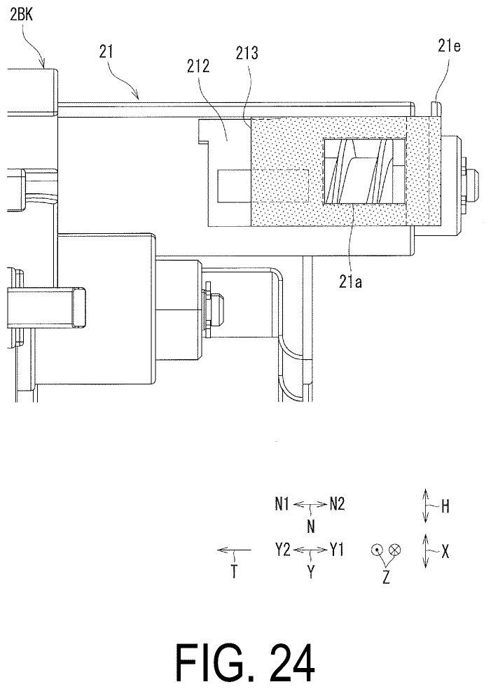

FIG. 24 is a bottom view illustrating an aspect in which an elastic member 213 is provided on the peripheral portion 212 in the developer discharge unit 21 with the shutter member 211 removed.

In the present embodiment, as illustrated in FIG. 24, the peripheral portion 212 in the developer discharge unit 21 can be provided with the elastic member 213 in order to suppress leakage of the developer from the discharge port 21a. In the example illustrated in FIG. 24, the elastic member 213 is bonded to the peripheral portion 212 by a double-sided adhesive sheet. In this case, the held portion 420 is inserted between the elastic member 213 provided on the peripheral portion 212 and the shutter member 211.

In detail, there is no gap between the peripheral portion 212 and the elastic member 213, but the peripheral portion 212 and the elastic member 213 are in light contact with each other. Therefore, by putting the held portion 420 in the sealing member 400 between the elastic member 213 and the shutter member 211, the held portion 420 can be held between the elastic member 213 and the shutter member 211, and the elastic member 213 exerts a force to press the held portion 420 toward the shutter member 211, so that the tip portion of the held portion 420 can be reliably held.

When the shutter member 211 moves from the closed state to the open state, a force acts on the held portion 420 in the sealing member 400 in a direction in which the shutter member 211 opens. This can further improve the tension of the held portion 420 against the discharge port 21a, thereby improving the contact with the peripheral portion 212.

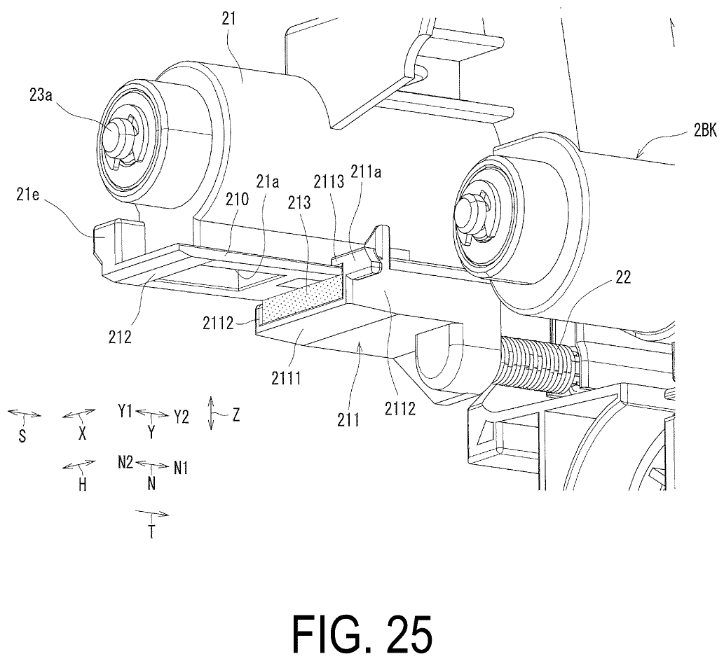

FIG. 25 is a perspective view of an aspect in which an elastic member 213 is provided on the shutter member 211, viewed obliquely from below. In FIG. 25, the shutter member 211 is in the open state.

In the present embodiment, as illustrated in FIG. 25, the shutter member 211 can be provided with the elastic member 213 on the discharge port 21a side in order to suppress leakage of the developer from the discharge port 21a. In the example illustrated in FIG. 25, the elastic member 213 is bonded to the shutter member 211 on the discharge port 21a side by a double-sided adhesive sheet. In this case, the held portion 420 in the sealing member 400 is inserted between the elastic member 213 provided on the shutter member 211 on the discharge port 21a side and the peripheral portion 212.

In detail, there is no gap between the peripheral portion 212 and the elastic member 213, but the peripheral portion 212 and the elastic member 213 are in light contact with each other. Therefore, by putting the held portion 420 in the sealing member 400 between the peripheral portion 212 and the elastic member 213, the held portion 420 can be held between the peripheral portion 212 and the elastic member 213, and the elastic member 213 exerts a force to press the held portion 420 toward the peripheral portion 212, so that the tip portion of the held portion 420 can be reliably held.

When the shutter member 211 moves from the closed state to the open state, a force acts on the held portion 420 in the sealing member 400 in the direction in which the shutter member 211 opens. This can further improve the tension of the held portion 420 against the discharge port 21a, thereby improving the contact between the held portion 420 and the peripheral portion 212.

In this configuration, the elastic member 213 can improve the sealing performance of the sealing portion 410.

In this example, the held portion 420 is inserted between the elastic member 213 and the shutter member 211 or the peripheral portion 212, and is thereby held in the gap SP. This can eliminate a gap between the shutter member 211 or the peripheral portion 212 and the elastic member 213, thereby reliably holding the held portion 420 (making the held portion 420 less likely to come off due to strong contact) between the elastic member 213 and the shutter member 211 or the peripheral portion 212, and further improving the sealing performance of the sealing portion 410.

Here, a thickness of the elastic member 213 is not limited to this, but may be, for example, about 1.0 mm to 4.0 mm. The elastic member 213 may be a porous member made of a foam material such as polyurethane foam, polyolefin foam, natural (NR) rubber sponge, chloroprene (CR) rubber sponge, or ethylene-propylene (EPDM) rubber sponge.

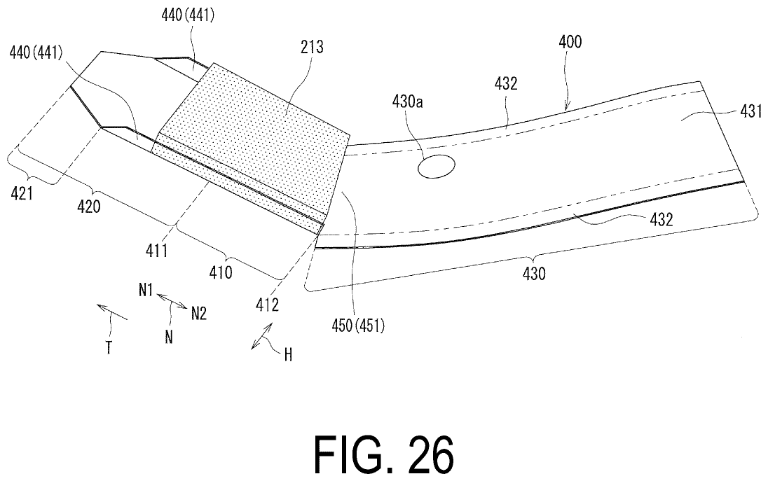

FIG. 26 is a perspective view illustrating an aspect in which an elastic member 213 is provided on the sealing member 400 illustrated in FIG. 8.

As illustrated in FIG. 26, the elastic member 213 may be provided at least on the sealing portion 410 of the sealing portion 410 and the held portion 420, instead of the peripheral portion 212. In the example illustrated in FIG. 26, the elastic member 213 is bonded to the entire sealing portion 410 and part of the held portion 420 by a double-sided adhesive sheet.

In this configuration, the elastic member 213 is provided at least on the sealing portion 410 of the sealing portion 410 and the held portion 420, so that the sealing performance of the sealing portion 410 can be improved due to the elastic member 213. When the elastic member 213 is provided on the sealing portion 410 and the held portion 420, the elastic member 213 can reliably hold the held portion 420 in the holding section 21b.

### 10th Embodiment

When the flexibility and elasticity of the sealing member 400 are too small, the sealing member 400 is easily deformed, and when the flexibility and elasticity of the sealing member 400 are too large, the sealing member 400 is hardly deformed. In either case, the handling properties of the sealing member 400 are deteriorated, thereby deteriorating the workability of attaching the sealing member 400.

Therefore, a thickness of the sealing member 400 is preferably, for example, about 0.075 mm to 0.2 mm. The bending strength is preferably about 96 MPa to 131 MPa. However, values are not limited to these values.

This can effectively prevent deterioration in the handling properties of the sealing member 400 and further deterioration in the workability of attaching the sealing member 400.

### 11th Embodiment

In the present embodiment, the sealing member 400 is a single sheet member in which the sealing portion 410, the held portion 420, and the fixed portion 430 are integrally connected.

In this way, the sealing member 400 can be easily formed by punching and/or bending the single sheet member.

### 12th Embodiment

In the present embodiment, the developer discharge unit 21 includes the transport screw 23 (see FIG. 7) that transports the developer to the discharge port 21a, the peripheral portion 212 that surrounds the discharge port 21a, and the shutter member 211 that is provided above the peripheral portion 212 that opens and closes the discharge port 21a. The holding section 21b has the gap SP between the peripheral portion 212 and the shutter member 211. The fixing section 21c includes the rotary shaft 23a of the transport screw 23. The fixed portion 430 has the insertion hole (an example of the engagement portion 430a) for the rotary shaft 23a of the transport screw 23. The sealing member 400 is held in the gap SP between the peripheral portion 212 and the shutter member 211 in the holding section 21b by inserting the held portion 420 into the gap SP, and the insertion hole (430a) in the fixed portion 430 is fixed to the rotary shaft 23a of the transport screw 23 in the fixing section 21c.

In this configuration, the gap SP between the existing peripheral portion 212 and shutter member 211 can be utilized as the holding section 21b, without providing a separate member. Further, the rotary shaft 23a of the existing transport screw 23 can be utilized as the fixing section 21c without providing a separate member. Therefore, the configuration for sealing the discharge port 21a can be further simplified and made less expensive.

### 13th Embodiment

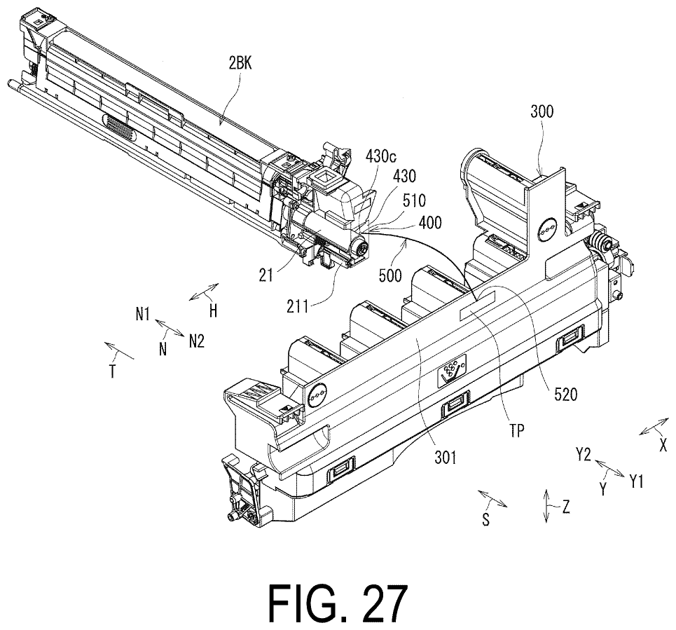

FIG. 27 is a perspective view illustrating an example of a long member 500 connected to the sealing member 400 and a detachable part (300).

In the present embodiment, the image forming device 100 further includes the detachable part (in this example, the collection container 300) that is detachably attached to the image forming device body 110, and the long member 500 that is used during packaging. During packaging, the long member 500 is connected to the sealing member 400 at a first end portion 510 thereof, and is connected to the detachable part (300) at a second end portion 520 thereof. In this example, the long member 500 is a string, the first end portion 510 thereof is connected to a connection hole 430c in the fixed portion 430 of the sealing member 400, and the second end portion 520 thereof is fixed to the collection container 300 (in this example, a front surface 301 of the collection container 300) with an adhesive tape TP for temporary fixing.

In this configuration, when the operator detaches the detachable part (300) from the image forming device body 110, with the second end portion 520 of the long member 500 connected to the detachable part (300), the first end portion 510 of the long member 500 pulls the sealing member 400, thereby releasing the discharge port 21a from the sealed state by the sealing member 400. That is, the discharge port 21a can be easily released from the sealed state by the sealing member 400 in conjunction with the detaching operation of the detachable part (300) from the image forming device body 110 by the operator.

Here, the long member 500 may be, for example, a string-shaped or belt-shaped long member 500 made of paper, natural fiber, synthetic fiber, or the like. In this example, the connection hole 430c is provided in the fixed portion 430 in the sealing member 400, and the first end portion of the long member 500 (in this example, the string-shaped long member 500) is connected to the connection hole 430c.

The disclosure is not limited to the embodiments described above and can be implemented in various other forms. Thus, the above embodiments are merely examples in all respects and should not be interpreted as limiting. The scope of the disclosure is indicated by the claims and is not limited to the description. Furthermore, all modifications and changes equivalent in scope with the claims are included in the scope of the disclosure.

### DESCRIPTION OF SYMBOLS

100 Image forming device
110 Image forming device body
21 Developer discharge unit
211 Shutter member
211a Abutted portion
212 Peripheral portion
213 Elastic member
21a Discharge port
21b Holding section
21c Fixing section
21d Support portion
22 Biasing member
23 Transport screw
23a Rotary shaft
24 E-ring
2BK Development device
2a Development tank
300 Collection container
31 Discharge roller
311 Abutment portion
400 Sealing member
410 Sealing portion
411 End portion on first side
412 End portion on second side
420 Held portion
421 Tip portion
430 Fixed portion
430a Engagement portion
430b Communication portion
431 Extension portion
440 Folded portion
441 Folded piece
442 Bent portion
450 Restricting portion
451 Abutment portion
500 Long member
510 First end portion
520 Second end portion
H Width direction
N Connection direction
N1 First side
N2 Second side
P11 Holding step
P12 Sealing step
P13 Fixing step
P21 Unfixing step
P22 Pulling-out step
S Attachment/detachment direction
SP Gap
T Insertion direction
X Left-right direction
Y Depth direction
Y1 First side
Y2 Second side
Z Up-down direction

1. A sealing member being a sheet member that seals a discharge port of a development device including a developer discharge unit provided with the discharge port, through the discharge port, developer being discharged, the sealing member comprising:
a sealing portion that seals the discharge port in the developer discharge unit;
a held portion that is connected to an end portion of the sealing portion on a first side in a predetermined connection direction and is detachably held by a holding section provided on the first side of the discharge port in the developer discharge unit in the connection direction; and
a fixed portion that is connected to an end portion of the sealing portion on a second side in the connection direction and is detachably fixed to a fixing section provided on the second side of the discharge port in the developer discharge unit in the connection direction.

2. The sealing member according to claim 1,
wherein at least the sealing portion of the sealing portion and the held portion includes a folded portion that is folded on both side surface sides of a peripheral portion that surrounds the discharge port in the developer discharge unit along both end sides of the peripheral portion in a width direction orthogonal to the connection direction of the peripheral portion.

3. The sealing member according to claim 1,
wherein the holding section has a gap between a peripheral portion that surrounds the discharge port in the developer discharge unit and a component of the development device, and
the held portion is held in the gap by being inserted into the gap.

4. The sealing member according to claim 3,
wherein a tip portion of the held portion is formed in a tapered shape, and in the tapered shape, a width in a width direction orthogonal to an insertion direction of the held portion becomes narrower on a downstream side as a distance from the sealing portion in the insertion direction increases.

5. The sealing member according to claim 3, further comprising:
a restricting portion that restricts movement of the sealing portion to a downstream side in an insertion direction of the held portion from a reference sealing position in a case where the held portion is inserted into the gap.

6. The sealing member according to claim 3,
wherein the component of the development device is a shutter member that opens and closes the discharge port with the gap existing between the shutter member and the peripheral portion, and
the held portion is held in the gap between the peripheral portion and the shutter member by being inserted into the gap.

7 . The sealing member according to claim 6,
wherein the held portion is inserted into the gap even in a case where the shutter member is in an open state.

8. The sealing member according to claim 1,
wherein the fixed portion includes an extension portion that extends beyond the fixing section on an opposite side of the discharge port.

9. The sealing member according to claim 1,
wherein the fixed portion includes an engagement portion having a shape identical to a shape of the fixing section, and is fixed by engaging the engagement portion with the fixing section.

10. The sealing member according to claim 3,
wherein the held portion is inserted between an elastic member provided on the peripheral portion that surrounds the discharge port and a shutter member, or is inserted between another elastic member provided on the shutter member on a discharge port side and the peripheral portion that surrounds the discharge port.

11. The sealing member according to claim 1,
wherein a thickness of the sealing member is 0.075 mm to 0.2 mm.

12. The sealing member according to claim 1,
wherein the sheet member is a single sheet member, and the sealing portion, the held portion, and the fixed portion are integrally connected in the single sheet member.

13. A development device including a developer discharge unit provided with a discharge port, the development device comprising:
the sealing member according to claim 1,
wherein the developer discharge unit includes
a holding section provided on the first side of the discharge port in the connection direction, and
a fixing section provided on the second side of the discharge port in the connection direction, and
in the sealing member, the held portion is detachably held by the holding section in the developer discharge unit, the fixed portion is detachably fixed by the fixing section in the developer discharge unit, and the sealing portion seals the discharge port in the developer discharge unit.

14. The development device according to claim 13,
wherein the developer discharge unit includes
a transport screw that transports the developer to the discharge port,
a peripheral portion that surrounds the discharge port, and
a shutter member that is provided above the peripheral portion and opens and closes the discharge port,
the holding section has a gap between the peripheral portion and the shutter member,
the fixing section includes a rotary shaft of the transport screw,
the fixed portion has an insertion hole for the rotary shaft of the transport screw, and
in the sealing member, by inserting the held portion into the gap between the peripheral portion and the shutter member, the held portion is held in the gap in the holding section and the insertion hole in the fixed portion is fixed to the rotary shaft of the transport screw in the fixing section.

15. An image forming device, comprising:
the development device according to claim 13.

16. The image forming device according to claim 15, further comprising:
a detachable part that is detachably attached to an image forming device body; and
a long member used during packaging,
wherein during packaging, a first end of the long member is connected to the sealing member, and a second end is connected to the detachable part.

17. A sealing method using the sealing member according to claim 1, the sealing method comprising:
holding the held portion in the sealing member in the holding section in the developer discharge unit;
sealing the discharge port in the developer discharge unit with the sealing portion in the sealing member; and
fixing the fixed portion in the sealing member to the fixing section in the developer discharge unit.
